(19) United States
(12) Patent Application Publication
(10) Pub. No.: US 2026/0179813 A1
(43) Pub. Date: Jun. 25, 2026

(54) INJECTION MOLDING MACHINE INTENDED FOR THE MANUFACTURE OF INJECTED PERMANENT MAGNET AND METHOD OF MANUFACTURING AN INJECTED PERMANENT MAGNET

(71) Applicant: NOVARES FRANCE, VELIZY-VILLACOUBLAY (FR)

(72) Inventors: Eric KMIEC, FRESNICOURT LE DOLMEN (FR); Nicolas DARGERE, MARCQ EN BAROEUL (FR); Cédric LEDIEU, MONT SAINT ELOI (FR)

(21) Appl. No.: 18/854,662

(22) PCT Filed: Mar. 29, 2023
(86) PCT No.: PCT/FR2023/050451

§ 371 Date: Oct. 7, 2024

(30) Foreign Application Priority Data
Apr. 7, 2022 (FR) 2203196

(51) Int. Cl. H01F 1/057; B29C 45/04; B29C 45/14; B29C 45/76; H01F 13/00; H01F 41/02

(52) U.S. Cl. CPC H01F 1/0577; B29C 45/045; B29C 45/14065; B29C 45/14073; B29C 45/14336; B29C 45/76; H01F 13/006; H01F 41/0266

(57) ABSTRACT

The present disclosure relates to an injection moulding machine for manufacturing injected permanent magnets, including: -a mould provided with an internal cavity; -a magnetisation device capable of applying a magnetic field inside the internal cavity of the mould; -at least one forming pin which is translatably movable with respect to the mould between a first position, referred to as an inoperative position, in which it is positioned entirely outside the mould, and a second position, referred to as an operative position, in which it is positioned inside the internal cavity of the mould; and -a demagnetisation device capable of removing any magnetisation from said at least one forming pin.

### CROSS REFERENCE TO RELATED APPLICATIONS

This application is a a National Stage of PCT Application No. PCT/FR2023/050451 filed on Mar. 29, 2023, which claims priority to French Patent Application No. 22/03196 filed on Apr. 7, 2022, the contents each of which are incorporated herein by reference thereto.

### TECHNICAL FIELD

The present disclosure relates to an injection molding machine intended for the manufacture of injected permanent magnet. The present disclosure also concerns a method for manufacturing an injected permanent magnet.

### BACKGROUND

In the automotive industry, it is common to use so-called permanent magnets to equip electric motors. Conventionally, these permanent magnets are obtained by sintering particles having magnetic properties. Another embodiment consists of preparing a mixture comprising a binder formed of a thermoplastic matrix and a magnetizable load comprising particles having magnetic properties and injecting the mixture into a mold provided with an internal cavity. The obtained injected part has an external shape corresponding to that of the internal cavity of the injection mold. An additional magnetization step is then performed in order to obtain an injected permanent magnet, called a plasto-magnet. A step of premagnetizing the material before filling the internal cavity of the mold can also be carried out. Injection molding machines suitable for implementing this second embodiment have been described in particular in documents US 2019/326052 A1 and DE 20 2018 103994 U1.

This second embodiment has the advantage of being able to form magnets of complex shape, which are in principle not achievable by sintering alone. In particular, it is thus possible to form molded magnets having one or more through cavities formed inside.

This embodiment, however, has the disadvantage of creating, in the case of hollow magnets, an inverse magnetization between the external periphery of the magnets and their internal periphery which delimits the through cavity or cavities of the magnet. This reverse magnetization phenomenon can therefore be annoying if a very specific magnetization profile is desired. In particular, this embodiment does not currently make it possible to carry out permanent magnets with orthoradial magnetization.

The present disclosure therefore aims to resolve this technical problem.

### BRIEF SUMMARY

For this purpose, the present disclosure concerns an injection molding machine intended for the manufacture of injected magnet, comprising:
a mold consisting of two portions, respectively a first portion and a second portion, disposed facing each other, the first portion being movable in translation relative to the second portion between a first position, corresponding to an open configuration of the mold, and a second position, corresponding to a closed configuration of the mold, said first and second portions being configured to form an internal cavity inside the mold when the latter is in its closed configuration, in which the mold is provided with a first through opening emerging onto the internal cavity, said first through opening allowing the introduction of a molding material inside the internal cavity, and in which the mold is provided with a second through opening emerging onto the internal cavity, said second through opening allowing the introduction of at least one shape pin inside the internal cavity;
a magnetization device capable of applying at least one magnetic field inside the internal cavity of the mold;
at least one shape pin movable in translation relative to the mold between a first position, called inactive position, in which it is entirely positioned outside the mold, and a second position, called active position, in which it is positioned inside the internal cavity of the mold;
a demagnetization device capable of removing any magnetization from said at least one shape pin.

Thus configured, the injection molding machine according to the present disclosure will make it possible to carry out permanent magnets provided with through cavities while avoiding the reverse magnetization phenomenon between the external periphery of the magnets and their internal periphery which delimits the through cavity or cavities of the magnet due to the use of a shape pin which ensures, in its active position, a magnetic continuity with the molding material during a magnetization step carried out by the magnetization device.

According to other characteristics, the machine of the present disclosure includes one or more of the following optional characteristics considered alone or in combination:
the magnetization device is disposed inside the mold so as to surround the internal cavity.
the demagnetization device is capable of applying at least one decreasing alternating magnetic field.
the demagnetization device is capable of applying at least one magnetic field controlled according to the so-called “knock-down” method.
said at least one shape pin is made of a ferromagnetic material.
the injection molding machine comprises a cylinder capable of moving said at least one shape pin between its inactive position and its active position, and vice versa.

The present disclosure also concerns a method for manufacturing an injected magnet comprising the following steps of:
a) providing an injection molding machine as defined above;
b) closing the mold of the molding machine;
c) moving said at least one shape pin of the molding machine from its inactive position to its active position, the pin having been previously subjected to a demagnetization by means of the demagnetization device of the molding machine;
d) injecting into the internal cavity of the mold a molding material comprising a binder and a magnetizable load comprising particles having magnetic properties;
e) preferentially applying a first magnetic field inside the internal cavity by means of the magnetization device of the molding machine, said first magnetic field being intended to align the particles of the magnetizable load in the same orientation;
f) applying a second magnetic field inside the internal cavity by means of the magnetization device of the molding machine, said second magnetic field being intended to confer specific magnetic properties, in particular a specific magnetic induction, to the assembly formed by the molding material overmolded on said at least one shape pin;
g) moving said at least one shape pin from its active position to its inactive position;
h) opening the mold;
i) demagnetizing said at least one shape pin by means of the demagnetization device;
j) extracting the injected part from the mold.

According to other characteristics, the method of the present disclosure includes one or more of the following optional characteristics considered alone or in combination:
steps d) and e) are carried out simultaneously.
steps i) and j) are carried out simultaneously.
the binder of the molding material is made of a material chosen from polyamide 6 (PA 6), polyamide 6-6 (PA 6-6), polyamide 12 (PA 12), polyphenylene sulfide (PPS), or any other thermoplastic material.
the particles having magnetic properties of the molding material are made of a material chosen from ferrite or a rare earth.

The present disclosure also concerns an injected permanent magnet obtained by the method as defined above, the permanent magnet being provided with at least one through cavity.

### BRIEF DESCRIPTION OF THE DRAWINGS

The present disclosure will be better understood on reading the non-limiting description which follows, made with reference to the attached figures.

FIG. 1 is a perspective view of an injection molding machine according to a particular embodiment of the present disclosure, the mold being in the open position and the shape pins being in the inactive position.

FIG. 2 is a view similar to FIG. 1, the mold being in the closed position and the shape pins being in the active position.

FIG. 3 is a schematic view of the molding machine of FIG. 1, the mold being in the open position and the shape pins being in the inactive position.

FIG. 4 is a view similar to FIG. 3, the mold being in the closed position and the shape pins being in the active position.

FIG. 5 is a perspective view of a mold that can equip the injection molding machine represented in FIGS. 1 to 4.

FIG. 6 is a diagram detailing the different steps constituting a manufacturing method according to the present disclosure.

### DETAILED DESCRIPTION

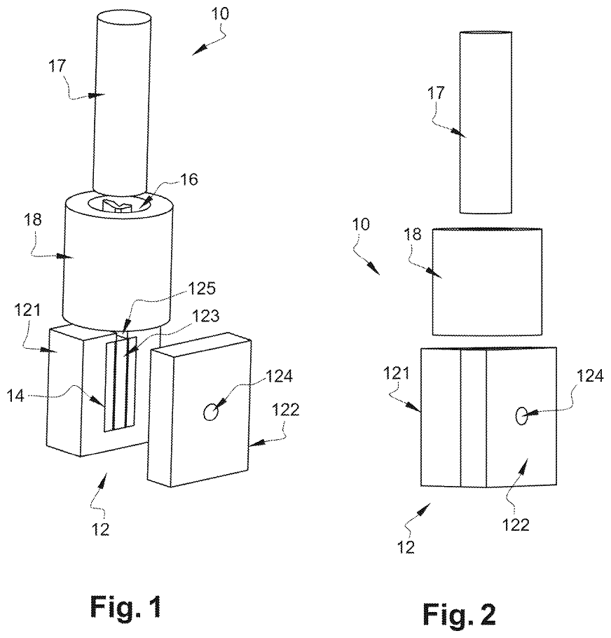

With reference to FIGS. 1 to 4, an injection molding machine according to the present disclosure is represented.

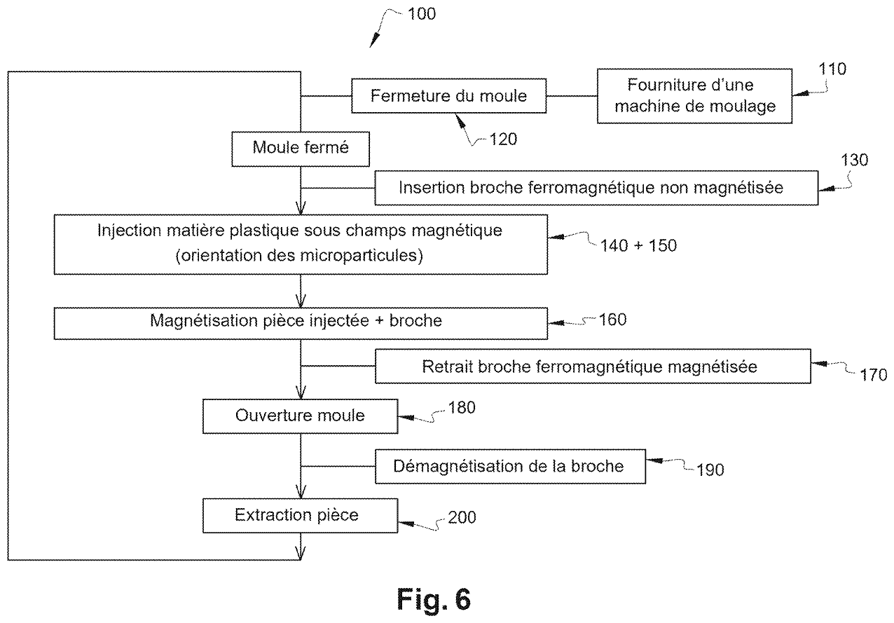

This injection molding machine 10 makes it possible to manufacture injected permanent magnets and is adapted to implement the steps of the manufacturing method 100 illustrated in the diagram of FIG. 6. The machine 10 notably comprises a mold 12 intended to receive a molding material inside an internal cavity 123 formed inside the mold 12, the cavity 123 having a specific three-dimensional profile corresponding to the three-dimensional profile of the magnet to be manufactured. In the case of a permanent magnet intended to equip an electric motor of a motor vehicle, this three-dimensional profile will advantageously correspond to a shape of right prism with a triangular, trapezoidal, or rectangular base, or to a cylindrical shape. The molding material is injected inside the mold 12 through a through opening 124 formed through the mold 12. Before the operation of injecting the material, at least one shape pin 16 is inserted into the mold 12 and the injected material is distributed around the pin 16. The through opening 124 is open to the outside at its first end and emerges, at its second end, onto the internal cavity 123.

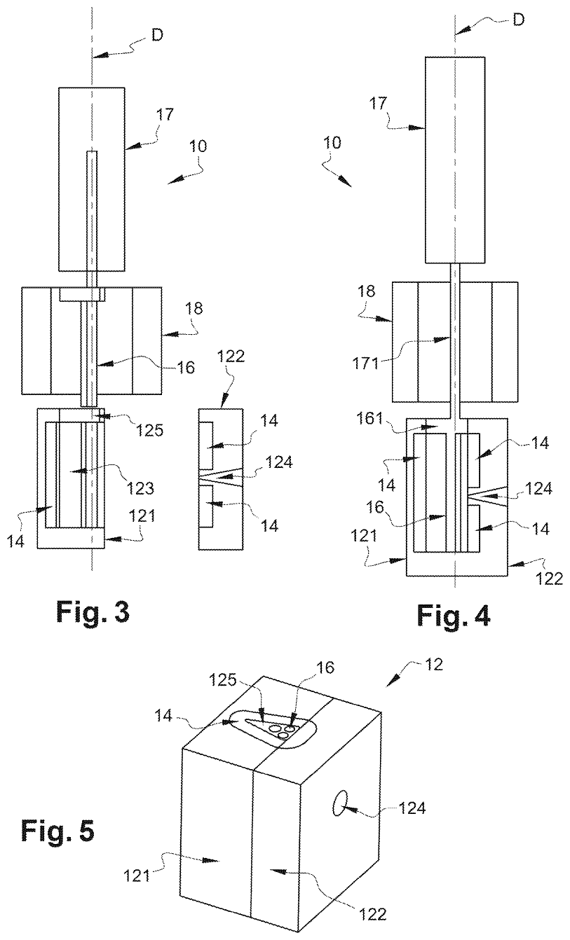

In the represented embodiment, the mold 12 consists of a first portion 121 and a second portion 122 which are disposed facing each other, the first portion 121 being able to move in translation relative to the second portion 122 between a first position represented in FIGS. 1 and 3, corresponding to an open configuration of the mold 12, and a second position represented in FIGS. 2 and 4, corresponding to a closed configuration of the mold 12. Each portion 121, 122 has a hollow shape at its internal face which is intended to come into contact with the other portion when the mold 12 is closed. The hollow shapes of the portions 121, 122 are configured to come into correspondence with one another in the closed position of the mold 12, thus forming the internal cavity 123 inside the mold 12.

The mold 12 also integrates a magnetization device 14 intended to apply a magnetic field inside the internal cavity 123. This magnetization device 14 will advantageously be formed of two portions, one which is secured to the first portion 121 and the other which is secured to the second portion 122, each of the portions partially surrounding the internal cavity 123. The magnetization device 14 may thus comprise one or more coils capable of generating a magnetic flux of variable intensity. As explained below, this magnetic flux will be used in particular during the phase of aligning the magnetic particles and during the phase of magnetizing the magnet.

The injection molding machine 10 is also equipped with at least one shape pin 16. This shape pin 16 is movable in translation relative to the mold 12 in a direction of displacement D, under the action for example of a cylinder 17 or an endless screw, between a first position, called inactive position, represented in FIGS. 1 and 3, in which it is positioned outside the mold 12, and a second position, called active position, represented in FIGS. 2 and 4, in which it is positioned at least partially inside the internal cavity 123 of the mold 12. For this purpose, a through opening 125 is provided in the wall of the mold 12 facing the shape pin 16 along the direction of displacement D. This through opening 125 has, in the plane perpendicular to the direction D, dimensions slightly greater than those of the shape pin 16. As represented in FIG. 4, the shape pin 16 may advantageously be configured, at its end 161 which is secured the rod 171 of the cylinder 17, so as to completely close the opening 125, when it is positioned in its active position. When it is in this active position, the shape pin 16 has the main function of restricting the volume available inside the internal cavity 123 of the mold 12 for the molding material, the molding material injected into the mold 12 then being overmolded with the shape pin 16. Thus, due to this restricted available space, the shape of the final injected part will be modified. In particular, by adequately choosing the shape of the shape pin 16 and the position thereof inside the internal cavity 123, it will be possible to form injected parts having one or more through cavities, each through cavity corresponding to the spaces occupied by a shape pin 16 inside the internal cavity 123 of the mold 12. Once the injection process is completed, and as described more further, it will be possible to remove the shape pin(s) 16 from the mold 12, via the cylinder 17, the final injected part then having one or more through cavities.

In the case of an injected part of the permanent magnet type, it is necessary to apply a magnetic field to the part during molding and/or after molding, in order, on the one hand, to pre-orientate, according to the same orientation, the particles of the magnetizable load of the molding material and, on the other hand, to confer specific magnetic properties, in particular a specific magnetic induction, to the molding material.

These two magnetization operations are, as described above, carried out by means of the magnetization device 14. In conventional injection molding machines, not equipped with shape pin(s), these two magnetization operations are applied to all portions of the mold. Therefore, during the manufacture of an injected permanent magnet provided with a through cavity by means of these conventional injection molding machines, a magnetization discontinuity occurs inside the injected magnet at the through cavity or cavities. This magnetization discontinuity leads to the reverse magnetization phenomenon, the faces at the external periphery of the magnet having a polarity opposite to those adjoining the through cavity of the magnet. The present disclosure aims to solve this problem by using the shape pin(s) 16. Indeed, the shape pin 16 also has the function of ensuring a magnetic continuity inside the injected magnet. For this purpose, it will advantageously be made of a ferromagnetic material. Thus, during magnetization operations, the presence of the shape pin 16 within the injected magnet will prevent the reverse magnetization phenomenon from occurring. It will therefore be possible to form, by means of the injection molding machine 10, injected permanent magnets provided with one or more through cavities, in which the magnetization profile may be better controlled and will not be dependent on the final three-dimensional geometry of the permanent magnet.

In order to carry out an optimal magnetization of the injected magnet, it is however essential that the shape pin 16 is unmagnetized when it is in the active position inside the mold 12. For this purpose, it is provided to equip the injection molding machine 10 with a demagnetization device 18 disposed upstream of the mold 12, the demagnetization device 18 being capable of removing any magnetization of the shape pin 16 before its introduction into the internal cavity 123 of the mold 12. This demagnetization device 18 will advantageously be positioned so as to act on the shape pin 16 when it is in its inactive position, outside the mold 12.

In the configuration represented in FIGS. 1 to 4, this demagnetization device 18 consists of one or more coils capable of applying either a decreasing alternating magnetic field, or a magnetic field controlled according to the so-called “knock-down” method. The “knock-down” method consists of generating an offset of the magnetic field by creating an opposing magnetic field by inverting polarity with stopping the source of the field. The magnetism in the shape pin 16 will thus become almost zero with a finely measured field adjustment. Concerning demagnetization by application of a decreasing alternating magnetic field, it can be obtained in two ways. The first consists of increasing the distance between the source of the magnetic field and the component to be demagnetized, the applied magnetic field decreasing with distance. The second consists of varying the magnetic field by means of a control unit, the component to be demagnetized remaining static.

In other embodiments of the present disclosure, the demagnetization device 18 may also consist of a heating device capable of raising the temperature of the shape pin 16 beyond the Curie temperature of the ferromagnetic material constituting this pin. It may also consist of a device capable of generating a strong vibration in the pin.

With reference to FIG. 5, there is represented an example of a mold that can be used in the injection molding machine according to the present disclosure. This mold 12 has a generally parallelepiped shape and consists of a first portion 121, of parallelepiped shape, and a second portion 122, of parallelepiped shape. The second portion 122 is crossed by a through opening 124, through which a molding material may be injected, said through opening 124 emerging into an internal cavity 123 (see FIG. 3) of the mold 12. A magnetization device 14 is disposed in the mold 12 so as to surround the internal cavity 123. One of the lateral faces of the first portion 121 is provided with a through opening 125 emerging into the internal cavity of the mold 12. This through opening 125 has a substantially triangular section and is dimensioned so as to allow the passage of at least one shape pin 16 whose section is preferably of cylindrical shape. The mold 12, thus configured, will make it possible to form injected magnets in the shape of a right prism with a triangular base, the magnets being provided with at least one through cavity with a cylindrical section.

With reference to FIG. 6, there is represented a diagram illustrating the succession of steps implemented during a manufacturing method 100 in accordance with the present disclosure, the manufacturing method making it possible to manufacture injected permanent magnets. It is clear that other additional steps could be provided in addition to said steps without departing from the scope of the present disclosure. Furthermore, the order in which these various steps will be carried out may be modified if necessary.

The manufacturing method 100 thus comprises the following steps of:
a) providing an injection molding machine 10 according to the present disclosure (step 110);
b) closing the mold 12 of the injection molding machine 10 (step 120);
c) moving the shape pin(s) 16 of the injection molding machine 10 from its inactive position to its active position, said shape pin(s) 16 having previously been subjected to a demagnetization by means of the demagnetization device 18 of the injection molding machine 10 (step 130);
d) injecting into the internal cavity 123 of the mold 12 a molding material comprising a binder and a magnetizable load comprising particles having magnetic properties (step 140);
e) preferentially applying a first magnetic field inside the internal cavity 123 by means of the magnetization device 14 of the injection molding machine 10, said first magnetic field being intended to align the particles of the magnetizable load according to the same orientation (step 150);
f) applying a second magnetic field inside the internal cavity 123, once the injected molding material has completely filled the internal cavity 123, by means of the magnetization device 14 of the molding machine 10, said second magnetic field being intended to confer specific magnetic properties, in particular a specific magnetic induction, to the assembly formed by the molding material overmolded on the shape pin(s) 16 (step 160);
g) moving the shape pin(s) 16 from their active position to their inactive position (step 170);
h) opening the mold 12 (step 180);
i) demagnetizing the shape pin(s) 16 by means of the demagnetization device 18 (step 190);
j) extracting the injected part from the mold 12 (step 200).

Step 150 may advantageously be implemented simultaneously with step 140, or at least, during a phase during which the binder of the molding material is still fluid, so that the magnetic particles may still move and orient according to the first magnetic field applied.

Step 190 may also advantageously be implemented simultaneously with step 200.

It should also be noted that, in the specific configuration represented in FIGS. 1 and 2, it will be necessary to also move the cylinder 17, the demagnetization device 18 and the shape pin(s) 16 during steps b) and h) in such a way that they are aligned axially with the through opening 125 of the mold 12 at the end of step b), the mold 12 being closed, and at the end of step h), the mold 12 being open.

1. An injection molding machine intended for the manufacture of injected magnet, comprising:
a mold consisting of two portions, respectively a first portion and a second portion, disposed facing each other, the first portion being movable in translation relative to the second portion between a first position, corresponding to an open configuration of the mold, and a second position, corresponding to a closed configuration of the mold, said first and second portions being configured to form an internal cavity inside the mold when the latter is in its closed configuration, in which the mold is provided with a first through opening emerging onto the internal cavity, said first through opening allowing the introduction of a molding material inside the internal cavity, and
in which the mold is provided with a second through opening emerging onto the internal cavity, said second through opening allowing the introduction of at least one shape pin inside the internal cavity;
a magnetization device capable of applying at least one magnetic field inside the internal cavity of the mold;
at least one shape pin movable in translation relative to the mold between a first position, called inactive position, in which it is entirely positioned outside the mold, and a second position, called active position, in which it is positioned inside the internal cavity of the mold;
a demagnetization device capable of removing any magnetization from said at least one shape pin.

2. The machine according to claim 1, wherein the magnetization device is disposed inside the mold so as to surround the internal cavity.

3. The machine according to claim 1, wherein the demagnetization device is capable of applying at least one decreasing alternating magnetic field.

4. The machine according to claim 1, wherein the demagnetization device is capable of applying at least one magnetic field controlled according to the so-called “knock-down” method.

5. The machine according to claim 1, wherein said at least one shape pin is made of a ferromagnetic material.

6. The machine according to claim 1, wherein it comprises a cylinder capable of moving said at least one shape pin between its inactive position and its active position, and vice versa.

7. A method for manufacturing an injected magnet comprising the following steps of:
a) providing an injection molding machine according to claim 1;
b) closing the mold of the molding machine;
c) moving said at least one shape pin of the molding machine from its inactive position to its active position, the pin having previously been subjected to a demagnetization by means of the demagnetization device of the molding machine;
d) injecting into the internal cavity of the mold a molding material comprising a binder and a magnetizable load comprising particles having magnetic properties;
e) preferentially applying a first magnetic field inside the internal cavity by means of the magnetization device of the molding machine, said first magnetic field being intended to align the particles of the magnetizable load in the same orientation;
f) applying a second magnetic field inside the internal cavity by means of the magnetization device of the molding machine, said second magnetic field being intended to confer specific magnetic properties, in particular a specific magnetic induction, to the assembly formed by the molding material overmolded on said at least one shape pin;
g) moving said at least one shape pin from its active position to its inactive position;
h) opening the mold;
i) demagnetizing said at least one shape pin by means of the demagnetization device;
j) extracting the injected magnet from the mold.

8. The manufacturing method according to claim 7, wherein steps d) and e) are carried out simultaneously.

9. The manufacturing method according to claim 7, wherein steps i) and j) are carried out simultaneously.

10. The manufacturing method according to claim 7, wherein the binder of the molding material is made of a material chosen from polyamide 6, polyamide 6-6, polyamide 12, polyphenylene sulfide, or any other thermoplastic material.

11. The manufacturing method according to claim 7, wherein the particles having the magnetic properties of the molding material are made of a material chosen from ferrite or a rare earth.

12. An injected permanent magnet obtained by the method according to claim 7, wherein the injected permanent magnet is provided with at least one through cavity.

13. The machine according to claim 2, wherein the demagnetization device is capable of applying at least one decreasing alternating magnetic field.

14. The machine according to claim 2, wherein the demagnetization device is capable of applying at least one magnetic field controlled according to the so-called “knock-down” method.

15. The machine according to claim 13, wherein said at least one shape pin is made of a ferromagnetic material.

16. The machine according to claim 14, wherein said at least one shape pin is made of a ferromagnetic material.

17. The machine according to claim 15, wherein it comprises a cylinder capable of moving said at least one shape pin between its inactive position and its active position, and vice versa.

18. The machine according to claim 16, wherein it comprises a cylinder capable of moving said at least one shape pin between its inactive position and its active position, and vice versa.

19. The manufacturing method according to claim 8, wherein steps i) and j) are carried out simultaneously.

20. The manufacturing method according to claim 19, wherein the binder of the molding material is made of a material chosen from polyamide 6, polyamide 6-6, polyamide 12, polyphenylene sulfide, or any other thermoplastic material.
